(19) United States
(12) Patent Application Publication
(10) Pub. No.: US 2026/0087090 A1
(43) Pub. Date: Mar. 26, 2026

(54) CONVTRANSPOSE TO CONV TRANSFORMATION: MAPPING CONVTRANSPOSE ON NEURAL PROCESSING UNITS ACCELERATORS FOR STANDARD CONVOLUTIONS

(71) Applicant: STMicroelectronics International N.V., Geneva (CH)

(72) Inventor: Alessandro BUSCHINI, Montano Lucino (IT)

(73) Assignee: STMicroelectronics International N.V., Geneva (CH)

(21) Appl. No.: 18/891,463

(22) Filed: Sep. 20, 2024

(51) Int. Cl. G06F 17/15; G06F 7/78

(52) U.S. Cl. CPC G06F 17/15; G06F 7/78

(57) ABSTRACT

Disclosed herein are processing techniques that enable existing convolution hardware accelerators to efficiently handle transposed convolution (ConvTranspose) operations. The method addresses both the arithmetic differences between convolution and ConvTranspose operations and the impact of ConvTranspose-specific hyperparameters. The method includes obtaining original ConvTranspose hyperparameters, expanding input features when stride exceeds 1 with solutions that can be optimized by mapping tools and hardware DMA, rotating kernel weights, transposing weights for multi-channel operations, and computing new convolution hyperparameters. These steps transform the ConvTranspose operation into an equivalent standard convolution operation performable on existing hardware. The technique accounts for various hyperparameters including pads, strides, dilations, and groups, ensuring accurate replication of ConvTranspose behavior. By enabling ConvTranspose operations on standard convolution hardware, this approach enhances the versatility and efficiency of neural network accelerators without requiring specialized hardware.

### TECHNICAL FIELD

This disclosure relates to the field of neural network computing, specifically to hardware acceleration of neural network operations. More particularly, this disclosure is directed to techniques for efficiently performing transposed convolution (ConvTranspose) operations using hardware accelerators designed for standard convolution operations.

### BACKGROUND

In the field of neural network computing, hardware acceleration has become increasingly important for improving the performance and efficiency of machine learning models. Neural Processing Units (NPUs) are specialized hardware components designed to accelerate the computation of common neural network operations.

One of the fundamental operations in many neural network architectures is the convolution operation, which involves applying a kernel (a matrix of weights) to an input feature map, which is a multi-dimensional array of numerical values representing the extracted features of activators from a previous layer or the initial input data itself. Consequently, many NPUs are optimized to perform convolution operations efficiently in hardware.

However, modern neural network architectures often employ a wider range of operations beyond standard convolutions. One such operation is the transposed convolution, also known as a ConvTranspose. This operation is widely used in various neural network applications, particularly in tasks involving upsampling or generating high-resolution outputs from low-resolution inputs.

The ConvTranspose operation, while conceptually related to standard convolution, involves a fundamentally different arithmetic process. While convolution applies each kernel to a corresponding input feature mask to produce a single output value, ConvTranspose applies each input value to the kernel to produce a single output mask for each input value.

This difference in arithmetic presents a challenge for hardware acceleration. NPUs are typically designed to support a specific set of operations natively, leaving the task of handling unsupported operations to software libraries or compilation toolchains. In the case of many current NPUs, ConvTranspose operations are not natively supported. This lack of native support for ConvTranspose operations results in several issues. For example, one resulting issue is that of reduced performance-when encountering ConvTranspose operations, systems fall back to software implementations, which are significantly slower than hardware-accelerated operations. Another resulting issue is that of increased complexity, as the need to handle ConvTranspose operations in software may actually increase the overall complexity of the system, requiring additional memory and processing resources. Finally, without hardware support, it becomes more challenging to optimize ConvTranspose operations in the context of the overall neural network computation, leaving limited optimization opportunities.

These issues are particularly problematic given the widespread use of ConvTranspose operations in modern neural network architectures. The inability to efficiently handle these operations can significantly impact the performance and applicability of neural network models on devices with limited resources or specialized hardware accelerators.

There is therefore a need for further development.

### SUMMARY

A method for performing a transposed convolution (ConvTranspose) operation using a convolution hardware accelerator. The method includes receiving input features for the ConvTranspose operation, where the input features are organized into one or more input channels, each channel representing a distinct feature map. At least one kernel including weights for the ConvTranspose operation is received, where the kernel is applied to the input features to produce output features. Original ConvTranspose hyperparameters are obtained, including pads defining additional zero-valued elements added to the borders of the input features, strides defining the step size for applying the kernel to the input features, dilations defining spacing between kernel elements, and groups defining how input channels and output channels are connected. When a ConvTranspose stride is greater than 1, the input features are expanded by interleaving zeros between each input feature value. Weights of the kernel are rotated by 180 degrees. When the ConvTranspose operation involves multiple input channels and multiple output channels, as determined by dimensions of the input features and the kernel, weights are transposed based on the groups. New convolution hyperparameters are computed based on the original ConvTranspose hyperparameters. The ConvTranspose operation is replaced with a standard convolution operation using various combinations of the expanded input features, rotated weights, transposed weights, and new convolution hyperparameters, depending on the stride and whether multiple input and output channels are involved.

The method may include expanding the input features when a ConvTranspose stride is greater than 1 by: a) concatenating constant zero-mask values along the channel axis of the input features to create an expanded set of channels, where the number of zero channels added is determined by multiplying the stride values in the height and width dimensions and subtracting one, thereby increasing the channel dimension of the input features; b) applying a DepthToSpace operation in Depth-Column-Row (DCR) mode to the expanded set of channels, using block sizes equal to the respective stride values in the height and width dimensions, thereby redistributing the added zero channels into the spatial dimensions of the input features; and c) when the redistributed input features do not match the required dimensions for the subsequent convolution operation, applying a padding operation to add additional zero-valued elements to some of the borders of the redistributed input features, or applying a cropping operation to remove excess elements from the borders of the redistributed input features, where resulting operations of concatenation, depth to space, and cropping are optimized with smart buffer allocation strategies at compile time and hardware direct memory access at runtime.

Expanding the input features may include calculating a number of zeros to be inserted between each input value based on the stride value for each dimension of the input features, and inserting additional zeros at borders of the input features to ensure that the output of the standard convolution operation has the same spatial dimensions as would be produced by the original ConvTranspose operation.

Transposing the weights based on the group parameter may include: when the group parameter equals 1, transposing the weights by switching the dimension representing the number of kernels with the dimension representing the number of kernel channels; when the group parameter equals the number of kernels, maintaining each kernels channels at their original positions to correspond to distinct output channels; and when the group parameter does not equal the number of kernels: reshaping the original weights tensor to add a dimension, transposing specific axes of this reshaped tensor, and reshaping back to the original number of dimensions.

Computing new convolution hyperparameters may include calculating new padding values for each dimension of the input features based on the dilation values, kernel size, and original padding values of the transposed convolution operation, where the dilation values determine the spacing between kernel elements.

The method may include, when negative padding is required and not supported by the convolution hardware accelerator, inserting an additional padding operation before the standard convolution operation to handle negative padding values.

The stride parameter of the standard convolution operation may be set to 1.

The dilation values of the standard convolution operation may remain unchanged from the original transposed convolution operation, where the dilation values determine the spacing between kernel elements.

A computing apparatus may be configured to implement the method described above.

### BRIEF DESCRIPTION OF THE DRAWINGS

FIG. 1 illustrates a simple convolution operation.

FIG. 2 illustrates a ConvTranspose operation.

FIG. 3 is a flowchart depicting the process described herein of transforming a ConvTranspose operation into a standard convolution operation.

FIG. 4 is a block diagram of a hardware system capable of performing ConvTranspose operations using standard convolution hardware utilizing the process described herein.

### DETAILED DESCRIPTION

The following disclosure enables a person skilled in the art to make and use the subject matter described herein. The general principles outlined in this disclosure can be applied to embodiments and applications other than those detailed above without departing from the spirit and scope of this disclosure. It is not intended to limit this disclosure to the embodiments shown, but to accord it the widest scope consistent with the principles and features disclosed or suggested herein.

Disclosed herein are processing techniques that allow existing convolution hardware accelerators, which are not designed to handle ConvTranspose operations, to nevertheless efficiently handle such operations. These techniques address not only the fundamental differences in the underlying arithmetic between convolution and ConvTranspose operations but also account for the distinct impact of ConvTranspose-specific hyperparameters. In this context, hyperparameters refer to the configurable settings that define the structure and behavior of the ConvTranspose operation, such as stride, padding, output padding, kernel size, and dilation. These hyperparameters affect the computation process differently in ConvTranspose operations compared to standard convolutions, influencing aspects like input-output size relationships and how the kernel is applied. The processing techniques described herein enable efficient processing of ConvTranspose operations on existing hardware, overcoming the challenges posed by both the arithmetic differences and the unique behavior of these associated hyperparameters.

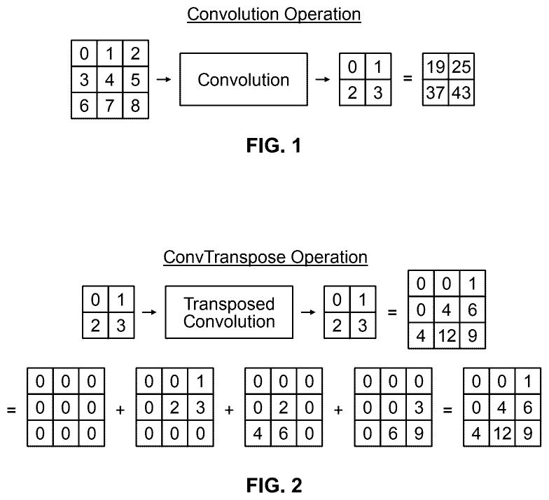

First, consider a simple convolution operation, diagrammatically illustrated in FIG. 1. The input feature mask is a 3-by-3 matix:

$$[ \begin{matrix}A 0 & A 1 & A 2 \\ A 3 & A 4 & A 5 \\ A 6 & A 7 & A 8\end{matrix} ] = [ \begin{matrix}0 & 1 & 2 \\ 3 & 4 & 5 \\ 6 & 7 & 8\end{matrix} ] ,$$

where the values of A0-A8 shown are example values.

The kernel is a 2-by-2 matrix:

$$[ \begin{matrix}B 0 & B 1 \\ B 2 & B 3\end{matrix} ] = [ \begin{matrix}0 & 1 \\ 2 & 3\end{matrix} ] ,$$

where the values of B0-B3 shown are example values.

To perform the convolution, each kernel is applied to a corresponding input feature mask, resulting in a single output value for each mask. The output of the convolution operation is as follows:

$$[ \begin{matrix}A 0 \times B 0 + A 1 \times B 1 + A 3 \times B 2 + A 4 \times B 3 = C 0 & A 1 \times B 0 + A 2 \times B 1 + A 4 \times B 2 + A 5 \times B 3 = C 1 \\ A 3 \times B 0 + A 4 \times B 1 + A 6 \times B 2 + A 7 \times B 3 = C 2 & A 4 \times B 0 + A 5 \times B 1 + A 7 \times B 2 + A 8 \times B 3 = C 3\end{matrix} ]$$

Plugging in the sample values, the output would then be:

$$[ \begin{matrix}0 \times 0 + 1 \times 1 + 3 \times 2 + 4 \times 3 = 19 & 1 \times 0 + 2 \times 1 + 4 \times 2 + 5 \times 3 = 25 \\ 3 \times 0 + 4 \times 1 + 6 \times 2 + 7 \times 3 = 37 & 4 \times 0 + 5 \times 1 + 7 \times 2 + 8 \times 3 = 43\end{matrix} ]$$

Thus, the convolution operation can be represented as:

$$[ \begin{matrix}A 0 & A 1 & A 2 \\ A 3 & A 4 & A5 \\ A 6 & A 7 & A 8\end{matrix} ] CONVOLUTION [ \begin{matrix}B 0 & B 1 \\ B 2 & B 3\end{matrix} ] = [ \begin{matrix}C 0 & C 1 \\ C2 & C 3\end{matrix} ] = [ \begin{matrix}0 & 1 & 2 \\ 3 & 4 & 5 \\ 6 & 7 & 8\end{matrix} ] CONVOLUTION [ \begin{matrix}0 & 1 \\ 2 & 3\end{matrix} ] = [ \begin{matrix}19 & 25 \\ 37 & 43\end{matrix} ]$$

Consider now a ConvTranspose operation, diagrammatically illustrated in FIG. 2. Here the input feature mask is a 2-by-2 matrix:

$$[ \begin{matrix}B 0 & B 1 \\ B 2 & B 3\end{matrix} ] = [ \begin{matrix}0 & 1 \\ 2 & 3\end{matrix} ] ,$$

where the values of B0-B3 shown are example values.

The kernel is a 2-by-2 matrix:

$$[ \begin{matrix}A 0 & A 1 \\ A 2 & A 3\end{matrix} ] = [ \begin{matrix}0 & 1 \\ 2 & 3\end{matrix} ] ,$$

where the values of A0-A3 shown are example values.

To perform the ConvTranspose, each input value is applied to the kernel, resulting in a single overlapping output mask for each input value. The output of the ConvTranspose operation is as follows:

$$[ \begin{matrix}C 0 & C 1 & C 2 \\ C 3 & C 4 & C 5 \\ C 6 & C 7 & C 8\end{matrix} ] = [ \begin{matrix}0 & 0 & 1 \\ 0 & 4 & 6 \\ 4 & 12 & 9\end{matrix} ]$$

This output can be understood as the sum of four separate operations, one for each input value:

$$[ \begin{matrix}B 0 \times A 0 & B 0 \times A 1 & 0 \\ B 0 \times A 2 & B 0 \times A 3 & 0 \\ 0 & 0 & 0\end{matrix} ] + [ \begin{matrix}0 & 0 & B 1 \times A 1 \\ 0 & B 1 \times A 2 & B 1 \times A 3 \\ 0 & 0 & 0\end{matrix} ] + [ \begin{matrix}0 & 0 & 0 \\ B 2 \times A 0 & B 2 \times A 1 & 0 \\ B 2 \times A 2 & B 2 \times A 3 & 0\end{matrix} ] + [ \begin{matrix}0 & 0 & 0 \\ 0 & B 3 \times A 0 & B 3 \times A 1 \\ 0 & B3 \times A 2 & B 3 \times A 3\end{matrix} ] = [ \begin{matrix}C 0 & C 1 & C 2 \\ C 3 & C 4 & C 5 \\ C 6 & C 7 & C 8\end{matrix} ]$$

Plugging in the sample values, the output would then be:

$$[ \begin{matrix}0 & 0 & 0 \\ 0 & 0 & 0 \\ 0 & 0 & 0\end{matrix} ] + [ \begin{matrix}0 & 0 & 1 \\ 0 & 2 & 3 \\ 0 & 0 & 0\end{matrix} ] + [ \begin{matrix}0 & 0 & 0 \\ 0 & 2 & 0 \\ 4 & 6 & 0\end{matrix} ] + [ \begin{matrix}0 & 0 & 0 \\ 0 & 0 & 3 \\ 0 & 6 & 9\end{matrix} ] = [ \begin{matrix}0 & 0 & 1 \\ 0 & 4 & 6 \\ 4 & 12 & 9\end{matrix} ]$$

Thus, the ConvTranspose operation can be represented as:

$$[ \begin{matrix}A 0 & A 1 \\ A 2 & A 3\end{matrix} ] CONVTRANSPOSE [ \begin{matrix}B 0 & B 1 \\ B 2 & B 3\end{matrix} ] = [ \begin{matrix}C 0 & C 1 & C 2 \\ C 3 & C 4 & C 5 \\ C 6 & C 7 & C 8\end{matrix} ]$$

Plugging in the sample values, the output would then be:

$$[ \begin{matrix}0 & 1 \\ 2 & 3\end{matrix} ] CONVTRANSPOSE [ \begin{matrix}0 & 1 \\ 2 & 3\end{matrix} ] = [ \begin{matrix}0 & 0 & 1 \\ 0 & 4 & 6 \\ 4 & 12 & 9\end{matrix} ]$$

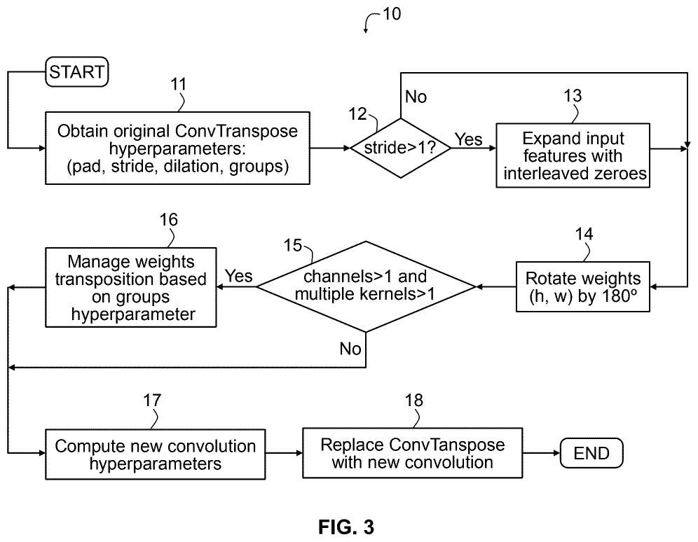

The details of the modified ConvTranspose operation disclosed herein, performable on existing convolution hardware accelerators, will now be described with reference to flowchart 10 of FIG. 3.

To begin, the original ConvTranspose hyperparameters are obtained (Block 11). These hyperparameters define how the kernel is applied to the input feature map to produce the output, and include pads, strides, dilations, and group.

The Pads hyperparameter refers to a list of integers defining padding for the beginning and ending along each spatial axis of the input feature map. This padding can take any value greater than or equal to 0 and is applied to the input before the transposed convolution operation.

The Stride hyperparameter refers to a list of integers defining the stride along each output spatial axis. In ConvTranspose, stride determines the distance in the output mask between the resulting projections of the input values on the kernel mask. If not specified, the stride defaults to 1 along each spatial axis. A stride greater than 1 means that the projections of input values contribute to output neighborhoods that are no longer adjacent, but are stride-1 units apart from each other. This often results in an upsampled output, as it increases the spacing between where input values influence the output.

The Dilations hyperparameter refers to a list of integers specifying the dilation value along each spatial axis of the filter (kernel). Dilation affects how the kernel is applied to the input, effectively increasing the kernel's receptive field without increasing its parameter count. If not specified, the dilation defaults to 1 along each spatial axis.

The Group hyperparameter refers to an integer specifying the number of groups input channels and output channels are divided into, determining how input channels are connected to output channels. The default value is 1.

These hyperparameters collectively determine how the ConvTranspose operation transforms the input feature map into a typically larger output feature map, controlling aspects such as spatial expansion, receptive field, and channel connectivity.

Operation then proceeds to the first decision point (Block 12) which checks if any ConvTranspose stride is greater than 1.

If this condition is met, the input features are expanded by interleaving zeros between each input feature value (Block 13). This simulates the behavior of ConvTranspose with stride >1, where input values contribute to output neighborhoods that are no longer adjacent.

Specifically, for each spatial dimension I, the number of zeros inserted between each input value is calculated as: ZerosBetweenEachInputValue=Strideᵢ−1.

This transformation effectively inflates the input feature map, allowing a standard convolution operation with stride 1 to mimic the upsampling effect inherent to ConvTranspose operations with stride >1. By doing this, each input value influences the correct set of output points as defined by the original ConvTranspose kernel and stride.

This operation can be performed as a series of steps: concatenation, DepthToSpace operation, and pad or crop operation.

In the concatenation step, constant zero-mask values are concatenated along the channel axis of the input features, which can be optimized at compile time using smart buffer allocation strategies.

The DepthToSpace operation is then applied in DCR (Depth-Column-Row) mode. This operation rearranges data from depth into blocks of spatial data. The DCR mode specifies the order in which the data is rearranged: first along the depth dimension, then the column dimension, and finally the row dimension. This is used to transform a tensor from a depth dimension to spatial dimensions, effectively upscaling the spatial resolution. In this context, it's used to distribute the concatenated zero values spatially. The block size for this operation is determined by the stride values:

BlockSizeₕ=scaleₕ=Strideₕ and BlockSize_{w}=scale_{w}=Stride_{w}.

Depending on the input size and stride values, a padding or cropping operation may be used to achieve the correct output dimensions.

The total number of zero channels to be added (ZeroChannels) is calculated as: ZeroChannels=scaleₕ*scale_{w}−1. This can be further optimized in several ways. The concatenation step can be optimized at compile time through efficient memory allocation. The DepthToSpace operation can be accelerated using Direct Memory Access (DMA) for efficient data movement.

Regardless of the outcome of the first decision point, the next step (Block 14) involves rotating the weights (kernel) by 180 degrees. This rotation, which involves flipping the kernel both horizontally and vertically, is crucial for transforming the ConvTranspose operation into an equivalent standard convolution operation that can be performed on existing hardware accelerators.

The rotation is done to maintain the correct spatial relationships in the transformed operation. It ensures that each input value contributes to the output in the same way as it would in the original ConvTranspose operation. This step accounts for the fact that ConvTranspose effectively reverses the spatial relationship of the kernel to the input compared to standard convolution.

For example, consider a 2-by-2 kernel in the original ConvTranspose operation, as follows:

$$[ \begin{matrix}e & f \\ g & h\end{matrix} ]$$

After rotation, it becomes the following in the transformed standard convolution operation:

$$[ \begin{matrix}h & g \\ f & e\end{matrix} ]$$

After rotating the weights in Block 14, the technique proceeds to the second decision point (Block 15). This step determines if the ConvTranspose operation involves multiple channels (>1) and multiple kernels (>1). This check is crucial as it affects how the weights need to be transposed.

If the condition (Block 15) is met, the process moves to management of weight transposition (Block 16), taking into account the groups hyperparameter. This step is particularly important when the groups parameter is greater than 1, as it affects how the channels are divided and processed.

Before explaining the weight transposition process, some terminology is to be clarified. Hereinbelow, channel-first notation refers to the convention of ordering dimensions in tensor operations, where the channel dimension comes before the spatial dimensions, and in the context of convolutional neural networks, N is the number of samples in a batch, C is the number of channels (for input) or number of filters (for output), H is the height of the feature map, W is the width of the feature map, and K is the number of kernels.

The weight transposition process (Block 16) varies depending on the value of the groups parameter.

When groups=1, which is the simplest case, a kernel is assigned to the related input channel. The number of output channels is determined by the number of channels in the kernels. To mimic the ConvTranspose behavior with a standard convolution, the weights are transposed by switching the KN (number of kernels) with KC (kernel channels) dimensions. For weights of [1, 0, 2, 3] the first two dimensions are swapped (0 and 1) while keeping the spatial dimensions (2 and 3) unchanged.

When groups=number of kernels (GROUPS=KN), a more complex case, each kernel's channels at the same index correspond to a distinct output channel, rather than summing up in a common output channel.

When groups is not equal to the number of kernels (GROUPS!=KN), the most complex case, each group includes KN/GROUPS kernels, so the transposition is managed within each group. The process then involves:
a) Reshaping the original weights tensor to add a dimension—from (KN,KC,KH,KW) to (GROUPS,KN/GROUPS,KC,KH,KW, where KH and KW are the kernel height and width respectively;
b) Transposing axes 1 and 2 of this reshaped tensor; and
c) Reshaping back to 4 dimensions: (GROUPS*KC,KN/GROUPS,KH,KW).

This weight transposition step provides that the standard convolution operation accurately mimics the behavior of the original ConvTranspose operation, particularly in how input channels are mapped to output channels and how the ‘groups’ parameter affects this mapping.

By carefully managing the weight transposition based on the groups parameter, this approach sees that the transformed operation maintains the mathematical relationships and channel interactions of the original ConvTranspose operation, even when using hardware designed for standard convolutions.

Following the weight transformations, the next step (Block 17) involves computing new Convolution hyperparameters to provide that the standard Convolution operation becomes mathematically equivalent to the original ConvTranspose operation.

The computation focuses primarily on adjusting the padding values, while other parameters like dilation and groups remain unchanged. The padding calculation in detail is performed as below:

For each spatial axis i:

Padding at the beginning of axis i is calculated as:

$${Pad}_{CONV \_ ai \_ begin} = {Dilation}_{CT \_ ai} \times ( {KernelSize}_{{axis}_{i}} - 1 ) - {Pad}_{CT \_ ai \_ begin}$$

Padding at the end of axis i is calculate as:

$${Pad}_{CONV \_ ai \_ end} = {Dilation}_{CT \_ ai} \times ( {KernelSize}_{{axis}_{i}} - 1 ) - {Pad}_{CT \_ ai \_ end}$$

To explain these components:
“axisᵢ” refers to each spatial dimension of the data, for example the height (H) and width (W);
Pad_{CONV_ai_begin} is the new padding to be applied at the start of axis i for the converted Convolution operation;
Pad_{CONV_ai_end} is the new padding to be applied at the end of axis i for the converted Convolution operation;
Dilation_{CT_ai} is the dilation rate of the original ConvTranspose operation along axis i, with dilation determining the spacing between kernel elements;
KernelSizeₐₓᵢₛ_{ᵢ} is the size of the kernel (filter) along axis i;
Pad_{CT_ai_begin} is the original padding at the start of axis i in the ConvTranspose operation; and
Pad_{CT_ai_end} is the original padding at the end of axis i in the ConvTranspose operation.

The expression Dilation_{CT_ai}×(KernelSizeₐₓᵢₛ_{ᵢ}−1) calculates the total expansion of the kernel due to dilation. Subtracting the original padding from this value gives the new padding used for the Convolution operation to mimic the ConvTranspose behavior.

Note that these calculations may result in negative padding values. However, some frameworks, such as ONNX (Open Neural Network Exchange), do not support negative padding as a Convolution attribute.

In cases where negative padding is desired but not supported, an additional Pad node is be inserted before the Convolution operation. This separate padding step handles negative padding values, providing for the correct input size for the subsequent Convolution operation.

The stride parameter of the new Convolution operation has to be set to 1, as the spatial expansion has already been handled by the input feature expansion step 13 (if performed earlier in the process).

By computing these new hyperparameters, particularly the adjusted padding values, this technique ensures that the transformed standard Convolution operation produces output that is identical to what the original ConvTranspose operation would have produced. This equivalence maintains the proper functionality while facilitating the use of standard convolution hardware for ConvTranspose operations.

The final step of the process (Block 18) involves replacing the original ConvTranspose operation with the newly configured standard Convolution operation. At this stage, appreciate that the input features have been potentially expanded with interleaved zeros (if stride >1), the kernel weights have been rotated by 180 degrees, the weights have been transposed based on the ‘groups’ parameter, and new hyperparameters, particularly padding values, have been computed for the Convolution operation.

Consider the following example:

For a 2-by-2 input matrix:

$$[ \begin{matrix}a & b \\ c & d\end{matrix} ]$$

And for the rotated 2-by-2 kernel:

$$[ \begin{matrix}h & g \\ f & e\end{matrix} ]$$

The resulting output of a convolution resulting from the transformation described above, with hyperparameters of stride=(1,1), pads=(1,1,1,1), dilation=(1,1), groups(1) is a 3-by-3 matrix where each cell represents a specific combination of input values and kernel weights:

$$[ \begin{matrix}a \times e & a \times f + b \times e & b \times f \\ a \times g + c \times e & a \times h + b \times g + c \times f + d \times e & b \times h + d \times f \\ c \times g & c \times d + d \times g & d \times h\end{matrix} ]$$

This output pattern is identical to what would be produced by the original ConvTranspose operation. The corner cells involve single input-kernel interactions, while the edge and center cells incorporate multiple interactions, with the center cell combining all input and kernel elements.

The preservation of this output structure demonstrates that the transformation described herein correctly maintains the mathematical relationships of the original ConvTranspose operation. It shows that the ConvTranspose operation has been converted into an equivalent standard convolution operation that can be performed on existing convolution hardware accelerators, while producing exactly the same output characteristics.

### Hardware

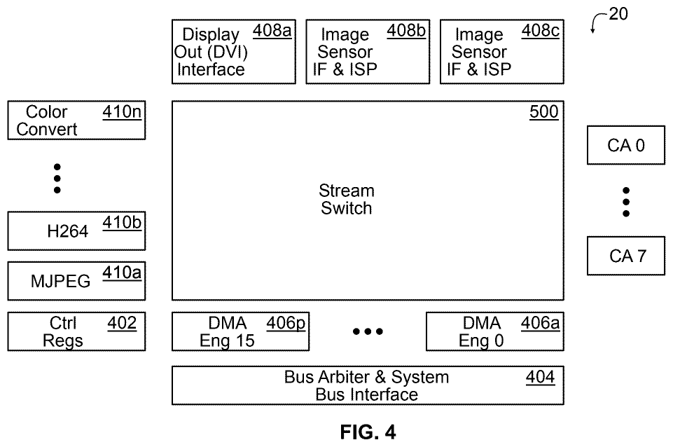

Described with reference to FIG. 4 is a hardware system 20 capable of performing ConvTranspose operations using standard convolution hardware. This system comprises several components that work together to implement the ConvTranspose operation. The Convolution Accelerators (CAs), labeled CA 0 to CA 7, are the core processing units originally designed for standard convolution operations but reconfigured to perform ConvTranspose operations. The Stream Switch 500 provides a reconfigurable interconnect framework, allowing flexible data flow between various components and routing data to and from the CAs during ConvTranspose operations.

DMA Controllers 406a, . . . , 406p manage data transfer between the system memory and the processing units, handling the expanded input features and transformed weights required for ConvTranspose operations. Control Registers 402 store the configuration parameters used for ConvTranspose operations, including the original ConvTranspose hyperparameters and the computed new convolution hyperparameters. The Bus Arbiter & System Bus Interface 404 manages communication between the ConvTranspose hardware and the rest of the SoC, facilitating data and control information transfer.

To implement ConvTranspose operations, the Control Registers 402 are first configured with the original ConvTranspose hyperparameters. If the ConvTranspose stride is greater than 1, the DMA controllers expand the input features by interleaving zeros. The CAs then perform the operations with rotated weights, which have been flipped 180 degrees. If the operation involves multiple input and output channels, the weights are also transposed based on the ‘groups’ parameter. The weight transposition and hyperparameter setting may be managed at compile time to optimize runtime performance. The Stream Switch 500 manages the data flow between components during these operations, while the Bus Arbiter & System Bus Interface 404 handles data transfer to and from system memory. This configuration allows the system to efficiently perform ConvTranspose operations using standard convolution hardware, demonstrating the flexibility of the design in adapting to different types of neural network operations without requiring specialized ConvTranspose hardware. By handling weight transposition and hyperparameter configuration at compile time, the system may reduce computational overhead during runtime, further enhancing efficiency.

Further details of hardware which can be used to perform the ConvTranspose operations using convolution hardware accelerators may be found in European Patent No. 3,346,427, related to U.S. patent Ser. No. 11/562,115, the contents of both of which are incorporated by reference in their entirety.

### Advantages

The disclosed processing techniques for handling ConvTranspose operations on existing convolution hardware accelerators represent a specific improvement to computer functionality, particularly in the realm of neural network computations. These advancements are directed to a concrete enhancement in the way computers operate, specifically targeting the efficiency and capability of neural network hardware accelerators. This technology improves the functioning of neural network hardware accelerators by enabling efficient ConvTranspose operations on existing hardware designed primarily for convolution operations. This is not a mere software implementation of a mathematical procedure, but a fundamental change in how the hardware processes these operations.

By reconfiguring how the hardware handles different types of neural network operations, this technology effectively increases the range of tasks that can be accelerated by existing hardware. This expansion of capabilities represents a tangible improvement in the functionality of the computer system. The techniques allow for faster processing of ConvTranspose operations on hardware not originally designed for such tasks, leading to increased speed and reduced power consumption. This results in concrete performance improvements in neural network computations. Furthermore, the new approach allows for more flexible configuration of neural network accelerators, enabling them to adapt to different types of operations without physical modifications. This increased flexibility represents a significant advancement in the versatility of neural network hardware.

These improvements are focused, technological advancements that enhance the capabilities of computer hardware in a specific and tangible way. The disclosed techniques address a problem particular to neural network accelerators—the inability to efficiently handle ConvTranspose operations—and provide a solution that is necessarily rooted in computer technology. Importantly, these advancements are directed to an improvement in computer capabilities, not on economic or other tasks for which a computer is used in its ordinary capacity. The improvement is to the functioning of the computer itself, specifically its ability to perform neural network computations more efficiently and flexibly.

In summary, the disclosed techniques provide a specific, concrete improvement to the functionality of neural network hardware accelerators. This technological advancement focuses on enhancing the core capabilities of computer systems, particularly in the realm of neural network processing. By enabling existing hardware to perform new types of operations efficiently, these techniques represent a significant step forward in the field of computer technology and neural network acceleration. The result is a more versatile, efficient, and powerful computing system that pushes the boundaries of what's possible in neural network computations, opening new avenues for advancement in artificial intelligence and machine learning applications.

Still further, this approach offers significant runtime performance improvements, particularly in speed and energy consumption. By enabling ConvTranspose operations to be managed within the Hardware Accelerators of the NPU Dataflow architecture, the scheduler can maintain uninterrupted epochs, avoiding the overhead associated with memory transfers for alternative kernel inference. This streamlined process reduces inference time and energy consumption by eliminating unnecessary memory read/write operations and leveraging optimized hardware inference.

The utilization of the dataflow internal path leads to a reduction in overall activation memory requirements. When the scheduler can group multiple hardware nodes together in the same epoch, it results in more efficient memory usage. This optimization is particularly valuable in resource-constrained environments or when dealing with large-scale neural networks that demand substantial memory resources.

An additional advantage is the compatibility with existing optimizations for standard convolution operations. All optimizations available for standard convolution operations remain valid for the convolution node resulting from the proposed transformation. This compatibility ensures that the benefits of previous research and development in optimizing convolution operations can be directly applied to ConvTranspose operations, further enhancing performance and efficiency.

From a development perspective, this approach simplifies the compilation toolchain development and reduces overall complexity. By eliminating the need to support alternative solutions or third-party software kernels, it allows developers to exploit already-known hardware units without modifying the mapping toolchain. This streamlines the development process and reduces the potential for errors and incompatibilities that can arise from integrating diverse solutions.

These additional advantages underscore the comprehensive improvements offered by this technique. By addressing performance, memory efficiency, optimization potential, and development simplicity, the proposed method provides a solution to the challenge of efficiently handling ConvTranspose operations on existing hardware. This approach ensures that the benefits extend beyond operational improvements, encompassing broader aspects of neural network accelerator design and implementation.

### CONCLUSION

It is evident that modifications and variations can be made to what has been described and illustrated herein without departing from the scope of this disclosure.

Although this disclosure has been described with a limited number of embodiments, those skilled in the art, having the benefit of this disclosure, can envision other embodiments that do not deviate from the disclosed scope. Furthermore, skilled persons can envision embodiments that represent various combinations of the embodiments disclosed herein made in various ways.

1. A method for performing a transposed convolution (ConvTranspose) operation using a convolution hardware accelerator, the method comprising:
receiving input features for the ConvTranspose operation, wherein the input features are organized into one or more input channels, each channel representing a distinct feature map;
receiving at least one kernel comprising weights for the ConvTranspose operation, wherein the kernel is applied to the input features to produce output features;
obtaining original ConvTranspose hyperparameters, wherein the hyperparameters include: pads defining additional zero-valued elements added to the borders of the input features, strides defining the step size for applying the kernel to the input features, dilations defining spacing between kernel elements, and groups defining how input channels and output channels are connected;
when a ConvTranspose stride is greater than 1, expanding the input features by interleaving zeros between each input feature value;
rotating weights of the kernel by 180 degrees;
when the ConvTranspose operation involves multiple input channels and multiple output channels, as determined by dimensions of the input features and the kernel, transposing weights based on the groups;
computing new convolution hyperparameters based on the original ConvTranspose hyperparameters;
when the ConvTranspose stride is greater than 1 and the ConvTranspose operation involves multiple input channels and multiple output channels, replacing the ConvTranspose operation with a standard convolution operation using the expanded input features, the rotated weights, the transposed weights, and the new convolution hyperparameters;
when the ConvTranspose stride is greater than 1 and the ConvTranspose operation does not involve multiple input channels and multiple output channels, replacing the ConvTranspose operation with a standard convolution operation using the expanded input features, the rotated weights, and the new convolution hyperparameters;
when the ConvTranspose stride is not greater than 1 and the ConvTranspose operation involves multiple input channels and multiple output channels, replacing the ConvTranspose operation with a standard convolution operation using the rotated weights, the transposed weights, and the new convolution hyperparameters; and
when the ConvTranspose stride is not greater than 1 and the ConvTranspose operation does not involve multiple input channels and multiple output channels, replacing the ConvTranspose operation with a standard convolution operation using the rotated weights and the new convolution hyperparameters.

2. The method of claim 1, wherein expanding the input features when a ConvTranspose stride is greater than 1 comprises: a) concatenating constant zero-mask values along the channel axis of the input features to create an expanded set of channels, wherein the number of zero channels added is determined by multiplying the stride values in the height and width dimensions and subtracting one, thereby increasing the channel dimension of the input features; b) applying a DepthToSpace operation in Depth-Column-Row (DCR) mode to the expanded set of channels, using block sizes equal to the respective stride values in the height and width dimensions, thereby redistributing the added zero channels into the spatial dimensions of the input features; and c) when the redistributed input features do not match the required dimensions for the subsequent convolution operation,
applying a padding operation to add additional zero-valued elements to some of the borders of the redistributed input features, or applying a cropping operation to remove excess elements from the borders of the redistributed input features, wherein resulting operations of concatenation, depth to space, and cropping are optimized with smart buffer allocation strategies at compile time and hardware direct memory access at runtime.

3. The method of claim 1, wherein expanding the input features comprises: calculating a number of zeros to be inserted between each input value based on the stride value for each dimension of the input features; and inserting additional zeros at borders of the input features to ensure that the output of the standard convolution operation has the same spatial dimensions as would be produced by the original ConvTranspose operation.

4. The method of claim 1, wherein transposing the weights based on the group parameter comprises:
when the group parameter equals 1, transposing the weights by switching the dimension representing the number of kernels with the dimension representing the number of kernel channels;
when the group parameter equals the number of kernels, maintaining each kernel's channels at their original positions to correspond to distinct output channels; and
when the group parameter does not equal the number of kernels: reshaping the original weights tensor to add a dimension, transposing specific axes of this reshaped tensor, and reshaping back to the original number of dimensions.

5. The method of claim 1, wherein computing new convolution hyperparameters comprises: calculating new padding values for each dimension of the input features based on the dilation values, kernel size, and original padding values of the transposed convolution operation, wherein the dilation values determine the spacing between kernel elements.

6. The method of claim 5, further comprising: when negative padding is required and not supported by the convolution hardware accelerator, inserting an additional padding operation before the standard convolution operation to handle negative padding values.

7. The method of claim 1, wherein the stride parameter of the standard convolution operation is set to 1.

8. The method of claim 1, wherein the dilation values of the standard convolution operation remain unchanged from the original transposed convolution operation, where the dilation values determine the spacing between kernel elements.

9. A computing apparatus configured to implement the method of claim 1.

10. A hardware system for performing a transposed convolution (ConvTranspose) operation using standard convolution hardware, the system comprising:
a plurality of convolution accelerators (CAs) configured to perform standard convolution operations;
a stream switch configured to provide a reconfigurable interconnect framework for data flow between components;
a plurality of Direct Memory Access (DMA) controllers configured to manage data transfer between system memory and the CAs;
control registers configured to store configuration parameters for ConvTranspose operations;
a bus arbiter and system bus interface configured to manage communication between the hardware system and a System-on-Chip (SoC); and
a processor configured to:
receive input features for the ConvTranspose operation;
receive at least one kernel comprising weights for the ConvTranspose operation;
obtain original ConvTranspose hyperparameters;
when a ConvTranspose stride is greater than 1, instruct the DMA controllers to expand the input features by interleaving zeros between each input feature value;
rotate weights of the kernel by 180 degrees;
when the ConvTranspose operation involves multiple input channels and multiple output channels, transpose weights based on a groups parameter;
compute new convolution hyperparameters based on the original ConvTranspose hyperparameters; and
configure the CAs to perform a standard convolution operation using the expanded input features (when applicable), the rotated weights, the transposed weights (when applicable), and the new convolution hyperparameters.

11. The hardware system of claim 10, wherein the processor is further configured to:
concatenate constant zero-mask values along the channel axis of the input features to create an expanded set of channels;
apply a DepthToSpace operation in Depth-Column-Row (DCR) mode to the expanded set of channels; and
apply a padding operation to add additional zero-valued elements to some borders of the redistributed input features or apply a cropping operation to remove excess elements from the borders of the redistributed input features.

12. The hardware system of claim 11, wherein the concatenation, DepthToSpace operation, and padding or cropping operations are optimized with smart buffer allocation strategies at compile time and hardware direct memory access at runtime.

13. The hardware system of claim 10, wherein the processor is further configured to:
calculate a number of zeros to be inserted between each input value based on the stride value for each dimension of the input features; and
insert additional zeros at borders of the input features to ensure that the output of the standard convolution operation has the same spatial dimensions as would be produced by the original ConvTranspose operation.

14. The hardware system of claim 10, wherein the processor is configured to transpose the weights based on the groups parameter by:
when the groups parameter equals 1, transposing the weights by switching the dimension representing the number of kernels with the dimension representing the number of kernel channels;
when the groups parameter equals the number of kernels, maintaining each kernel's channels at their original positions to correspond to distinct output channels; and
when the groups parameter does not equal the number of kernels: reshaping the original weights tensor to add a dimension, transposing specific axes of this reshaped tensor, and reshaping back to the original number of dimensions.

15. The hardware system of claim 10, wherein the processor is configured to compute new convolution hyperparameters by calculating new padding values for each dimension of the input features based on dilation values, kernel size, and original padding values of the transposed convolution operation.

16. The hardware system of claim 15, wherein the processor is further configured to: when negative padding is required and not supported by the CAs, insert an additional padding operation before the standard convolution operation to handle negative padding values.

17. The hardware system of claim 10, wherein the processor is configured to set the stride parameter of the standard convolution operation to 1.

18. The hardware system of claim 10, wherein the processor is configured to maintain the dilation values of the standard convolution operation unchanged from the original transposed convolution operation.
